(19) United States
(12) Patent Application Publication
(10) Pub. No.: US 2008/0125037 A1
(43) Pub. Date: May 29, 2008

(54) Method and system for routing of FM data to a bluetooth A2DP link

(76) Inventors: Brima Ibrahim, Aliso Viejo, CA (US); Mitchell Buznitsky, Pinabete, CA (US); Angel Polo, San Diego, CA (US); John Walley, Ladera Ranch, CA (US)

Correspondence Address: MCANDREWS HELD & MALLOY, LTD, 500 WEST MADISON STREET, SUITE 3400, CHICAGO, IL, 60661, US

(21) Appl. No.: 11/508,631

(22) Filed: Aug. 23, 2006

(51) Int. Cl. H04B 7/00

(52) U.S. Cl. 455/41.2

(57) ABSTRACT

Certain aspects of a method and system for routing of FM Data to a Bluetooth A2DP link may comprise converting FM data to A2DP format by processing the FM data within a single chip with integrated Bluetooth and FM radios. The A2DP formatted data may be communicated to a Bluetooth device via an ACL link using an A2DP profile. The single chip may receive at least one signal, or command, from a host that starts conversion and transmission to at least one Bluetooth device via the ACL link using the A2DP profile and may, after receiving the initiation by the host, convert the FM data to A2DP formatted data without further intervention from the host. Power may be reduced to at least a portion of the host during the conversion process if the host is not needed for other processes.

### CROSS-REFERENCE TO RELATED APPLICATIONS/INCORPORATION BY REFERENCE

This application also makes reference to U.S. application Ser. No. 11/286,555 (Attorney Docket No. 16663US02) filed on Nov. 22, 2005. The above stated application is hereby incorporated herein by reference in its entirety.

### FIELD OF THE INVENTION

Certain embodiments of the invention relate to wireless communication technologies. More specifically, certain embodiments of the invention relate to a method and system for routing of FM data to a Bluetooth A2DP link.

### BACKGROUND OF THE INVENTION

With the popularity of portable electronic devices and wireless devices that support audio applications, there is a growing need to provide a simple and complete solution for audio communications applications. For example, some users may utilize Bluetooth-enabled devices, such as headphones and/or speakers, to allow them to communicate audio data with their wireless handset while freeing to perform other activities. Other users may have portable electronic devices that may enable them to play stored audio content and/or receive audio content via broadcast communication, for example.

However, integrating multiple audio communication technologies into a single device may be costly. Combining a plurality of different communication services into a portable electronic device or a wireless device may require separate processing hardware and/or separate processing software. Moreover, coordinating the reception and/or transmission of data to and/or from the portable electronic device or a wireless device may require significant processing overhead that may impose certain operation restrictions and/or design challenges. For example, operation of a plurality of radios in a mobile terminal may result in increases in power consumption. Since batteries can only supply limited power in mobile terminals, careful design may minimize battery usage.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for routing of FM data to a Bluetooth A2DP link, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a block diagram of exemplary mobile terminals with Bluetooth and FM radios that receive FM transmissions, which may be utilized in connection with an embodiment of the invention.

FIG. 1B illustrates an exemplary Bluetooth piconet, which may be utilized in connection with an embodiment of the invention.

FIG. 2 is a block diagram illustrating an exemplary Bluetooth enabled mobile terminal capable of receiving FM signals, in accordance with an embodiment of the invention.

FIG. 3A is a block diagram of an exemplary Bluetooth controller with integrated Bluetooth and FM radios that supports Bluetooth and FM operations, in accordance with an embodiment of the invention.

FIG. 3B is a block diagram of an exemplary Bluetooth controller with integrated Bluetooth and FM radios that supports multiple interfaces, in accordance with an embodiment of the invention.

FIG. 3C is a block diagram that illustrates an exemplary usage of a mobile terminal with FM and Bluetooth radio devices, in accordance with an embodiment of the invention.

FIG. 4A is a diagram of a Bluetooth data packet, which may be utilized in connection with an embodiment of the invention.

FIG. 4B is a diagram of an access code field of a Bluetooth data packet, which may be utilized in connection with an embodiment of the invention.

FIG. 4C is a diagram of a header field of a Bluetooth data packet, which may be utilized in connection with an embodiment of the invention.

FIG. 4D is a diagram of a payload field of a Bluetooth data packet, which may be utilized in connection with an embodiment of the invention.

FIG. 4E is a diagram of a payload header field of a Bluetooth data packet, which may be utilized in connection with an embodiment of the invention.

FIG. 5 is a flow diagram that illustrates exemplary steps for communicating FM data to a Bluetooth enabled headset, in accordance with an embodiment of the invention.

FIG. 6 is a flow diagram that illustrates exemplary steps for processing FM signals for communication to a Bluetooth enabled headset, in accordance with an embodiment of the invention.

### DETAILED DESCRIPTION OF THE INVENTION

Certain embodiments of the invention may be found in a method and system for transporting or routing of FM data to a Bluetooth A2DP link. Aspects of the invention may comprise converting received FM data, or FM signals, to A2DP format by processing the FM data within a single chip with an integrated Bluetooth radio and an integrated FM radio. The A2DP formatted FM data may be communicated to a Bluetooth device via an ACL link using an A2DP profile. The single chip may receive at least one signal, or a command, from a host to cause initiation of a process to transmit the FM data to at least one Bluetooth device via the ACL link using the A2DP profile. The processing may comprise SBC encoding of the FM data. The A2DP formatted FM data may comprise left channel and right channel information of the FM data. The A2DP formatted FM data may also comprise baseband signal of the FM data digitally sampled at 48 kilo-samples per second.

The single chip, after receiving the initiation signal from the host, may convert the received FM signal to A2DP formatted signal without further intervention from the host. Accordingly, an amount of power supplied to at least a portion of the host may be reduced during the converting instances where the host may not be needed for other processes, such as, for example, handling an incoming call or an outgoing call.

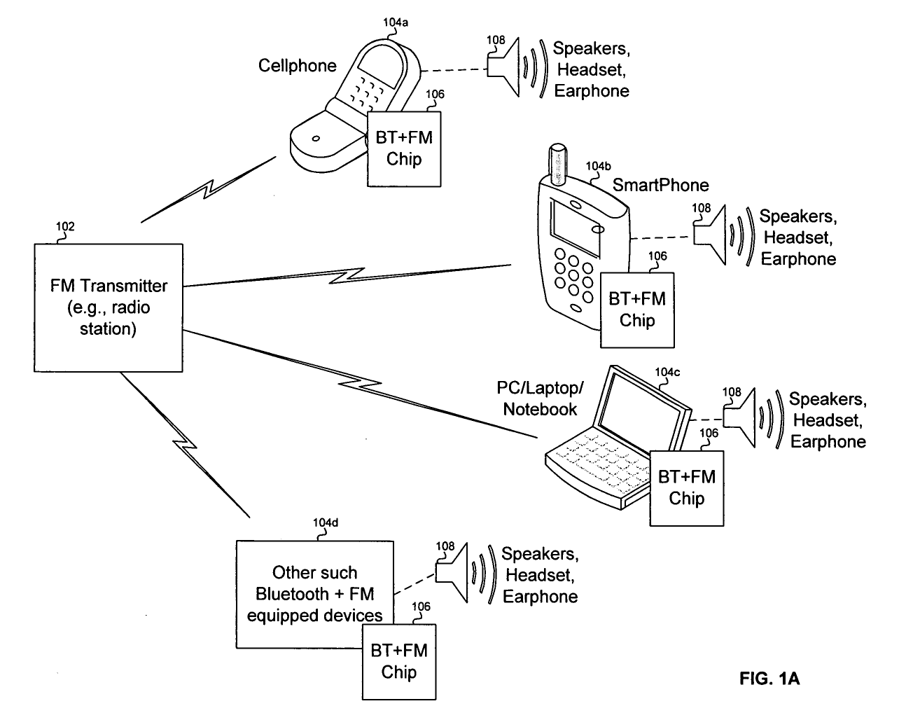

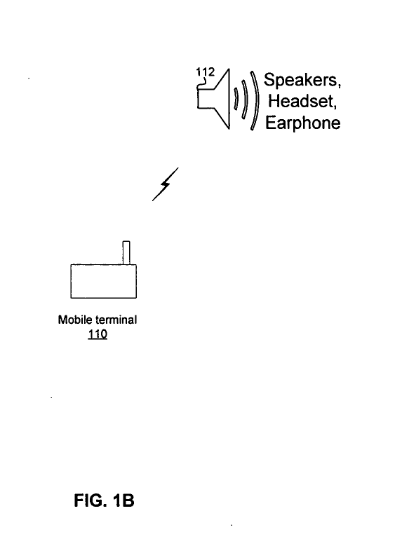

FIG. 1A is a block diagram of exemplary mobile terminals with Bluetooth and FM radios that receive FM transmissions, in accordance with an embodiment of the invention. Referring to FIG. 1A, there is shown an FM transmitter 102 and mobile terminals, such as, for example, a cellular phone 104a, a smart phone 104b, a computer 104c, and an exemplary FM and Bluetooth-equipped device 104d. The FM transmitter 102 may be implemented as part of a radio station or other broadcasting device, for example. Each of the cellular phone 104a, the smart phone 104b, the computer 104c, and the exemplary FM and Bluetooth-equipped device 104d may comprise a single chip 106 with integrated Bluetooth and FM radios for supporting FM and Bluetooth data communications. The FM transmitter 102 may enable communication of FM audio data to the devices shown in FIG. 1A by utilizing the single chip 106. Each of the devices in FIG. 1A may comprise and/or may be communicatively coupled to a listening device 108 such as a speaker, a headset, or an earphone, for example. Each device in FIG. 1A may be communicatively coupled to a listening device 108 via a Bluetooth link, for example.

The cellular phone 104a may be enabled to receive an FM transmission signal from the FM transmitter 102. The user of the cellular phone 104a may then listen to the transmission via the listening device 108. The cellular phone 104a may comprise a “one-touch” programming feature that enables pulling up specifically desired broadcasts, like weather, sports, stock quotes, or news, for example. The smart phone 104b may be enabled to receive an FM transmission signal from the FM transmitter 102. The user of the smart phone 104b may then listen to the transmission via the listening device 108.

The computer 104c may be a desktop, laptop, notebook, tablet, and a PDA, for example. The computer 104c may be enabled to receive an FM transmission signal from the FM transmitter 102. The user of the computer 104c may listen to the transmission via the listening device 108. While a cellular phone, a smart phone, computing devices, and other devices have been shown in FIG. 1A, the single chip 106 may be utilized in a plurality of other devices and/or systems that receive and use Bluetooth and/or FM signals.

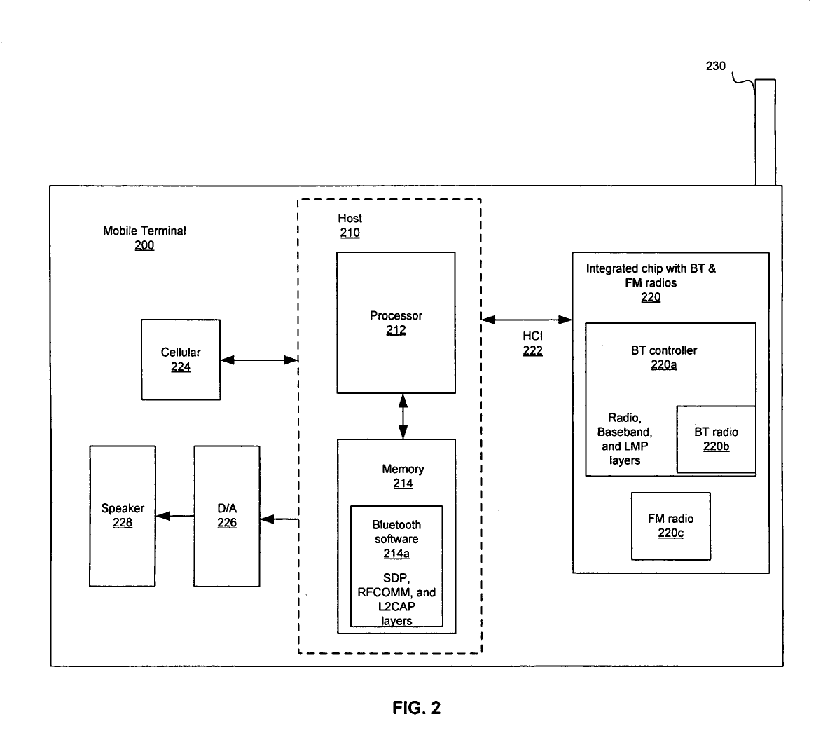

An embodiment of the invention may allow a Bluetooth enabled device, such as, for example, the cell phone 104a, to receive FM broadcast and to transmit the information in the FM broadcast to, for example, a Bluetooth enabled headset such as the listening device 108 with very little intervention by a Bluetooth host in the cell phone 104a. Accordingly, at least a portion of the Bluetooth host may be, for example, supplied with reduced power. This may be explained in more detail with respect to FIGS. 2, 3A, 3B, 3C, 4A, 4B, 4C, 4D, 4E, 5, and 6.

FIG. 1B illustrates an exemplary Bluetooth piconet, which may be utilized in connection with an embodiment of the invention. Referring to FIG. 1B, there is shown a Bluetooth enabled mobile terminal 110 and a Bluetooth enabled headset 112. These Bluetooth devices, or host platforms, may have a Bluetooth application and a Bluetooth communication device for transmitting and receiving signals. Each host device may then be considered to be a Bluetooth device. Up to eight Bluetooth devices may communicate with each other in a local network called a piconet. In a given piconet, only one Bluetooth device may be a master, while the others may be slaves.

The process for designating a master may be a dynamic process each time a piconet is set up. A Bluetooth device may be a member of multiple piconets, where it may be designated as a master device for one piconet, and a slave device for another piconet. Each Bluetooth device may use an algorithm that takes into account different variables, for example, performance and power requirements, in deciding whether it may want to be a master device. For example, since transmitting signals to locate other Bluetooth devices to form a piconet may utilize and transmission bandwidth, a Bluetooth device may wait passively for other Bluetooth devices to try to establish a piconet. A Bluetooth device that finds other Bluetooth devices, and establishes a connection with one or more Bluetooth devices, may be designated as the master Bluetooth device for that piconet.

With respect to the embodiments of the invention, a piconet may comprise the mobile terminal 110 and the headset 112. The mobile terminal 110 may receive FM transmission, and may transmit the information in the received FM transmission to the headset 112. This may be explained in more detail with respect to FIGS. 2, 3A, 3B, 3C, 4A, 4B, 4C, 4D, 4E, 5, and 6.

FIG. 2 is a block diagram illustrating an exemplary Bluetooth enabled mobile terminal capable of receiving FM signals, in accordance with an embodiment of the invention. Referring to FIG. 2, there is shown a mobile terminal 200, which may be one of the mobile terminals 104a, 104b, 104c, or 104d. The mobile terminal 200 may comprise a host 210, an integrated chip with Bluetooth and FM radios (BT-FM chip) 220, a host-controller interface (HCI) 222, a cellular block 224, a digital-to-analog converter (DAC) 226, at least one speaker 228, and an antenna 230. The host 210 may comprise a processor 212 and memory 214. Bluetooth software 214a may be stored in the memory 214, where the Bluetooth software 214a may comprise higher layers of Bluetooth protocol. The higher layers may comprise, for example, logical link control and adaptation protocol (L2CAP), RFCOMM protocol, and service discovery protocol (SDP).

The SDP layer may provide a means for applications to discover which services may be provided by or may be available through a Bluetooth device. It may also allow applications to determine the characteristics of those available services, such as, for example, a service class for a specific service. The RFCOMM protocol may provide emulation of RS232 serial ports over the L2CAP. For example, the RFCOMM may allow support of up to 60 simultaneous connections between two Bluetooth devices. The number of connections that may be used simultaneously in a Bluetooth device may be implementation-specific. With respect to RFCOMM, a complete communication path may involve two applications running on different devices (the communication endpoints) with a communication segment between them. The RFCOMM protocol may accommodate two types of Bluetooth devices. Type 1 devices may be communication end points such as computers and printers. Type 2 devices may be those that are part of the communication segment, such as, for example, modems.

The L2CAP layer supports higher-level protocol multiplexing, packet segmentation and reassembly, and the conveying of quality of service information. Accordingly, the L2CAP layer provides connection-oriented and connectionless data services to upper layer protocols with protocol multiplexing capability, segmentation and reassembly operation, and group abstractions. L2CAP permits higher-level protocols and applications to transmit and receive L2CAP data packets, where each packet may be up to 64 kilobytes in length.

The processor 212 may comprise suitable logic, circuitry, and/or code that may enable control and/or management operations in at least portions of the mobile terminal 200. In this regard, the processor 212 may communicate control and/or management operations to the host 210 and the BT-FM chip 220. Moreover, the processor 212 may be utilized to process data received by the mobile terminal 200 and/or to process data to be transmitted by the mobile terminal 200.

The memory 214 may comprise suitable logic, circuitry, and/or code that may enable storing of data and code, and reading of the stored data and the code. For example, the Bluetooth software 214a may be stored in the memory 214. The Bluetooth software 214a may be executed by the processor 212 to process the data received from the BT-FM chip 220. The Bluetooth software 214a may also be used to process data to communicate to the BT-FM chip 220, which may transmit the data to other Bluetooth devices.

The BT-FM chip 220 may comprise a Bluetooth controller 220a and a FM radio 220c. U.S. application Ser. No. 11/286,555 (Attorney Docket No. 16663US02) filed on Nov. 22, 2005, provides an exemplary communication system that utilizes a single chip integrated Bluetooth and FM transceiver and baseband processor and is hereby incorporated herein by reference in its entirety.

The Bluetooth controller 220a may comprise a Bluetooth radio 220b. The Bluetooth radio 220b may comprise suitable logic, circuitry, and/or code that may enable Bluetooth transmission of data to other Bluetooth devices and reception of Bluetooth transmission from other Bluetooth devices. The Bluetooth controller 220a may also enable communication of data to and from the host 210. The Bluetooth controller 220a may comprise lower layers of the Bluetooth protocol, such as, for example, link manager protocol (LMP) layer, baseband layer, and the radio layer. A link manager on each Bluetooth device may use the LMP to set up and control communication links. The baseband layer is the physical layer of the Bluetooth protocol. It is used to manage physical channels and links apart from other services like error correction, data whitening, hop selection and Bluetooth security. The baseband layer is above the radio layer in the Bluetooth protocol stack. The baseband layer is implemented as a Link Controller, which works with the link manager for carrying out link level routines like link connection and power control. The baseband layer also manages asynchronous and synchronous links, handles packets and does paging and inquiry to access and inquire Bluetooth devices in the area. The bottommost layer, the radio layer, defines the requirements for a Bluetooth transceiver operating in the 2.4 GHz ISM band.

The Bluetooth controller 220a may process the received signals and communicate the processed signals to the host 210. The Bluetooth controller 220a may also enable transmitting Bluetooth signals to other Bluetooth devices. The Bluetooth controller 220a may process signals received from the host 210 before transmission to other Bluetooth devices. The host 210 and the Bluetooth controller 220a may communicate with each other via one or more links over the HCI 222. Although HCI may be a protocol, for simplicity, the term HCI may also be used to refer to a physical interface that may be used with the HCI protocol. The HCI protocol may be used with or without a physical interface.

The FM radio 220c may comprise suitable logic, circuitry, and/or code that may enable reception of FM transmission, such as, for example, commercial FM radio broadcast. The cellular block 224 may comprise suitable logic, circuitry, and/or code that may enable wireless communication via, for example, a cellular network (not shown).

In operation, a user of the mobile terminal 200, which may be, for example, a Bluetooth enabled cellular phone that can also receive FM broadcasts, may wish to listen to broadcasts from an FM radio station, such as, for example, the FM transmitter 102. Accordingly, the user may, for example, select an option on a menu to play music from an FM station. The host 210 may send commands to the BT-FM chip 220 via a HCI link to initiate transmission of the received FM broadcast signals to a Bluetooth headset, such as, for example, the listening device 108. The BT-FM chip 220 may then receive the FM broadcast and transmit the information in the FM broadcast to the listening device 108 without further intervention from the host 210. An embodiment of the invention may then reduce power to the host 210 to conserve battery power in instances where the host 210 may not be needed for other processes.

The FM radio 220c may process the received FM signals to digital baseband FM data. The digital baseband data may be further processed for Bluetooth transmission. For example, Bluetooth enabled devices may transmit high quality audio using the advanced audio distribution profile (A2DP) protocol. Accordingly, the digital baseband FM data may be encoded by a sub-band coding (SBC) codec and processed for transmission to other Bluetooth devices using the A2DP protocol. The processed digital baseband FM data may be modulated, upconverted to RF frequencies, and the RF frequency signals may be transmitted via the antenna 230.

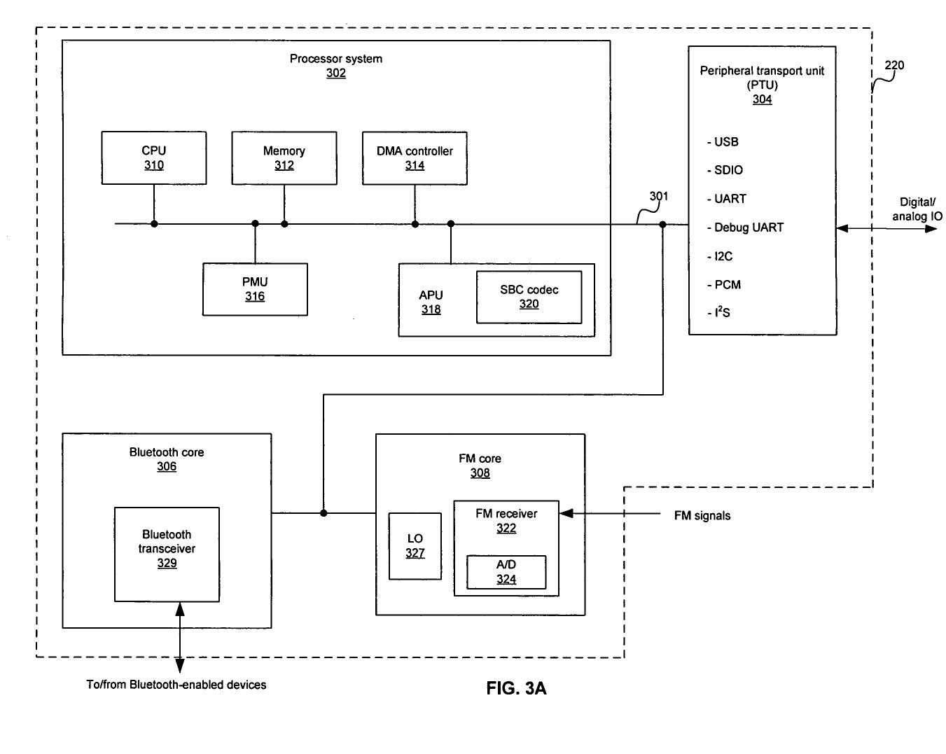

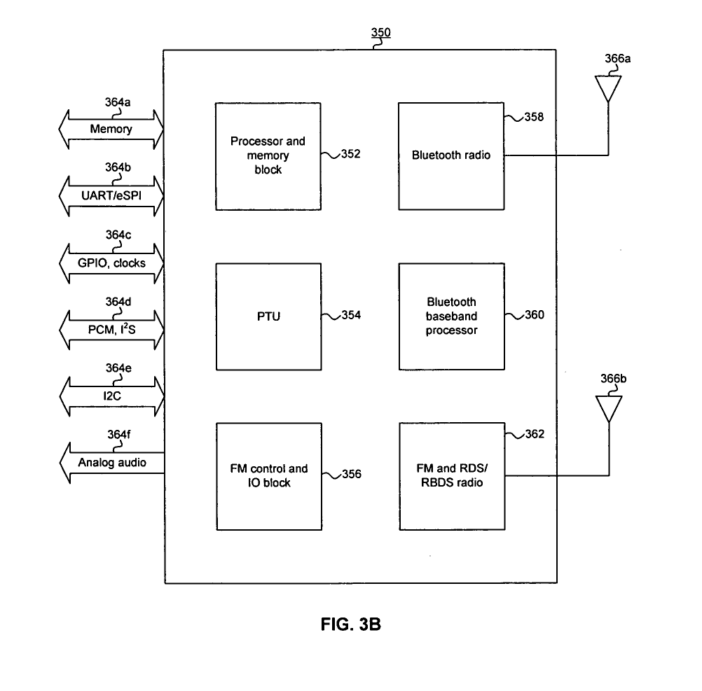

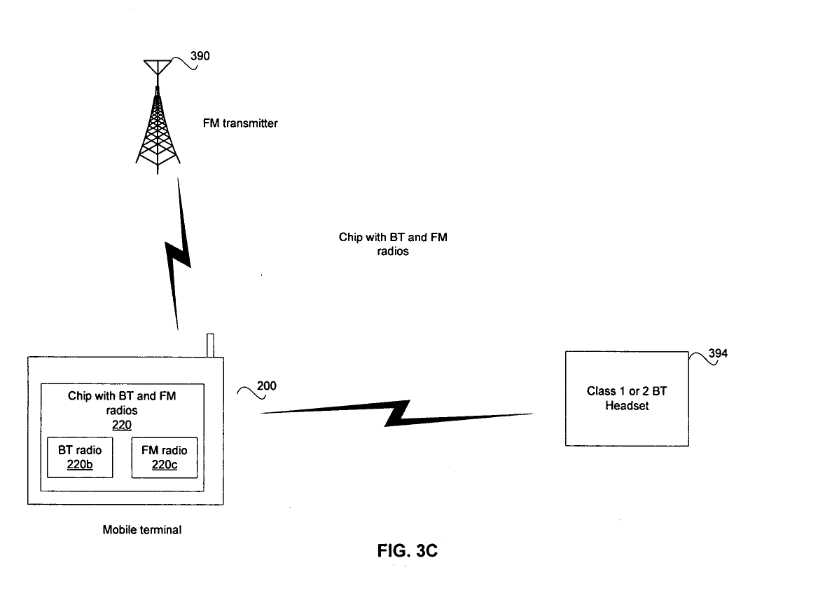

FIG. 3A is a block diagram of an exemplary Bluetooth controller with integrated Bluetooth and FM radios that supports Bluetooth and FM operations, in accordance with an embodiment of the invention. Referring to FIG. 3A, there is shown the BT-FM chip 220 that may comprise a processor system 302, a peripheral transport unit (PTU) 304, a Bluetooth core 306, a frequency modulation (FM) core 308, and a common bus 301. The BT-FM chip 220 may be implemented, for example, in a single integrated circuit, or chip. The processor system 302 may comprise a central processing unit (CPU) 310, a memory 312, a direct memory access (DMA) controller 314, a power management unit (PMU) 316, and an audio processing unit (APU) 318.

The CPU 310 may comprise suitable logic, circuitry, and/or code that may enable control and/or management operations in the BT-FM chip 220. In this regard, the CPU 310 may communicate control and/or management operations to the Bluetooth core 306, the FM core 308, and/or the PTU 304 via a set of register locations specified in a memory map. Moreover, the CPU 310 may be utilized to process data received by the BT-FM chip 220 and/or to process data to be transmitted by the BT-FM chip 220. The CPU 310 may enable processing of data received via the Bluetooth core 306, via the FM core 308, and/or via the PTU 304. For example, the CPU 310 may enable processing of received FM data to baseband FM data and may then transfer the baseband FM data to other components of the BT-FM chip 220 via the common bus 301. For example, the baseband FM data may be communicated to the host 210, where the host 210 may further process the baseband FM data, in order, for example, to play the FM music and/or information via the speaker 228.

The memory 312 may comprise suitable logic, circuitry, and/or code that may enable data storage. In this regard, the memory 312 may be utilized to store data that may be utilized by the processor system 302 to control and/or manage the operations of the BT-FM chip 220. The memory 312 may also be utilized to store data received by the BT-FM chip 220 via the PTU 304 and/or via the FM core 308. Similarly, the memory 312 may be utilized to store data to be transmitted by the BT-FM chip 220 via the PTU 304. The DMA controller 314 may comprise suitable logic, circuitry, and/or code that may enable transfer of data directly to and from the memory 312 via the common bus 301 without involving the operations of the CPU 310.

The PMU 316 may comprise suitable logic, circuitry, and/or code that may enable providing various levels of power to various circuitry, such as, for example, the processor system 302, as needed to conserve power. The APU 318 may comprise a subband coding (SBC) codec 320. The SBC codec 320 may be an audio coding system specially designed for Bluetooth audio and video applications to obtain high quality audio at medium bit rates, and to have a low computational complexity. The SBC codec 320 may use 4 or 8 subbands, an adaptive bit allocation algorithm, and simple adaptive block PCM quantizers.

The PTU 304 may comprise suitable logic, circuitry, and/or code that may enable communication to and from the BT-FM chip 220 via a plurality of communication interfaces. The PTU 304 may support, for example, digital communication with at least one port. For example, the PTU 304 may support at least one of a universal serial bus (USB) interface, a secure digital input/output (SDIO) interface, or a universal asynchronous receiver transmitter (UART) interface, where one of those interfaces may be utilized for Bluetooth data communication. One of these three interfaces may be used, for example, for the HCI 222 between the BT-FM chip 220 and the host 210.

The Bluetooth core 306 may comprise suitable logic, circuitry, and/or code that may enable reception and/or transmission of Bluetooth data. The Bluetooth core 306 may comprise a Bluetooth radio, such as, for example, Bluetooth transmitter/receiver 329, that may perform reception and/or transmission of Bluetooth data. The Bluetooth core 306 may support amplification, filtering, modulation, and/or demodulation operations, for example. The Bluetooth core 306 may enable data to be transferred from and/or to the processor system 302, the PTU 304, and/or the FM core 308 via the common bus 301, for example.

The FM core 308 may comprise suitable logic, circuitry, and/or code that may enable reception of FM data. The FM core 308 may comprise a FM radio, such as, for example, FM receiver 322, and a local oscillator (LO) 327. The FM receiver 322 may comprise an analog-to-digital converter (ADC) 324. The FM receiver 322 may support amplification, filtering, and/or demodulation operations, for example. The LO 327 may be utilized to generate a reference signal that may be utilized by the FM core 308 for performing analog and/or digital operations. The FM core 308 may enable data to be transferred from and/or to the processor system 302, the PTU 304, and/or the Bluetooth core 306 via the common bus 301, for example.

Moreover, the FM core 308 may receive analog FM signals via the FM receiver 322. The FM receiver 322 may downconvert the analog FM signals to analog baseband FM signals. The ADC 324 in the FM receiver 322 may be utilized to convert the analog baseband FM signals to corresponding digital baseband FM data to enable processing by the FM core 308. The ADC 324 may, for example, sample the analog signal at 48 kilo-samples per second. Data received by the FM core 308 may be routed out of the FM core 308 in digital format via the common bus 301, for example. The FM core 308 may enable radio reception at various frequencies, such as, 400 MHz, 900 MHz, 2.4 GHz and/or 5.8 GHz, for example. The FM core 308 may also support operations at the standard FM band comprising a range of about 76 MHz to 108 MHz, for example.

In one exemplary embodiment of the invention, the digital baseband FM data from the FM core 308 and may transfer the digital baseband FM data to the Bluetooth core 306 via the common bus 301. The digital baseband FM data may be communicated to the host 210 via ACL packets. The host 210 may execute portions of the Bluetooth software 214a to retrieve the digital baseband FM data from the ACL packets. The digital baseband FM data may be processed to an analog signal, and the analog signal may be played via at least one speaker 228.

Although FIG. 3a may have used an example of receiving analog FM signals, an embodiment of the invention may also operate in conjunction with a FM receiver that receives digital FM signals. While some embodiments of the invention may be implemented for use with an SBC codec, the invention need not be so limited. Other codecs, such as, for example, MP2, MC may also be used with various embodiments of the invention.

FIG. 3B is a block diagram of an exemplary Bluetooth controller with integrated Bluetooth and FM radios that supports multiple interfaces, in accordance with an embodiment of the invention. Referring to FIG. 3B, there is shown a single chip 350 that supports Bluetooth and FM radio communications. The single chip 350 may comprise a processor and memory block 352, a PTU 354, an FM control and input-output (IO) block 356, a Bluetooth radio 358, a Bluetooth baseband processor 360, and an FM radio 362. A first antenna or antenna system 366a may be communicatively coupled to the Bluetooth radio 358. A second antenna or antenna system 366b may be communicatively coupled to the FM radio 362.

The processor and memory block 352 may comprise suitable logic, circuitry, and/or code that may enable control, management, data processing operations, and/or data storage operations, for example. The PTU 354 may comprise suitable logic, circuitry, and/or code that may enable interfacing the single chip 350 with external devices. The FM control and IO block 356 may comprise suitable logic, circuitry, and/or code that may enable control of at least a portion of the FM radio 362. The Bluetooth radio 358 may comprise suitable logic, circuitry, and/or code that may enable Bluetooth communications via the first antenna 366a. The FM radio 362 may comprise suitable logic, circuitry, and/or code that may enable FM reception via the second antenna 366b. The Bluetooth baseband processor 360 may comprise suitable logic, circuitry, and/or code that may enable processing of baseband data received from the Bluetooth radio 358 or baseband data to be transmitted by the Bluetooth radio 358.

The PTU 354 may support a plurality of interfaces. For example, the PTU 354 may support an external memory interface 364a, a universal asynchronous receiver transmitter (UART) and/or enhanced serial peripheral interface (eSPI) interface 364b, and a general purpose input/output (GPIO) and/or clocks interface 364c.

In operation, the FM radio 362 may receive FM signals transmitted by, for example, the FM transmitter 102. The transmitted signals may be received from the second antenna 366b. The FM signals may be processed to a corresponding digital baseband data by the FM radio 362. The digital baseband data may be communicated to, for example, the processor and memory block 352. The processor and memory block 352 may, for example, SBC encode the digital baseband data. The SBC encoded data may be communicated to the Bluetooth baseband processor 360, which may further process the SBC encoded data for Bluetooth transmission. The processed data may then be communicated from the Bluetooth baseband processor 360 to the Bluetooth radio 356. The Bluetooth radio 358 may apply appropriate filtering, amplification, and modulation to generate Bluetooth RF signals that may be transmitted. The Bluetooth RF signals may be communicated from the Bluetooth radio 358 to the first antenna 366a for transmission to other Bluetooth devices.

FIG. 3C is a block diagram that illustrates an exemplary usage of a mobile terminal with FM and Bluetooth radio devices, in accordance with an embodiment of the invention. Referring to FIG. 3C, there is shown a FM transmitter 390, the mobile terminal 200, and a Bluetooth headset 394. The mobile terminal 200 may comprise a BT-FM chip 220 with the Bluetooth radio 220b and the FM radio 220c.

The FM transmitter 390 may transmit FM signals, and the FM signals may be received by the mobile terminal 200. The mobile terminal 200 may comprise a receiver device, for example, the FM radio 220c, which may enable reception of FM signals. The mobile terminal 200 may communicate with, for example, the Bluetooth headset 394 via the Bluetooth radio 220c. The Bluetooth headset 394 may comprise suitable hardware, logic, circuitry, and/or code that may be adapted to receive and/or transmit audio information.

The FM receiver 200c in the mobile terminal 200 may be enabled to receive the FM signals from the FM transmitter 390. The received FM signals may be processed by, for example, the FM receiver 200c, the processor system 302, and the Bluetooth radio 200b in the mobile terminal 200. The processed FM signals may be suitable for transmission via the Bluetooth link to the BT headset 394.

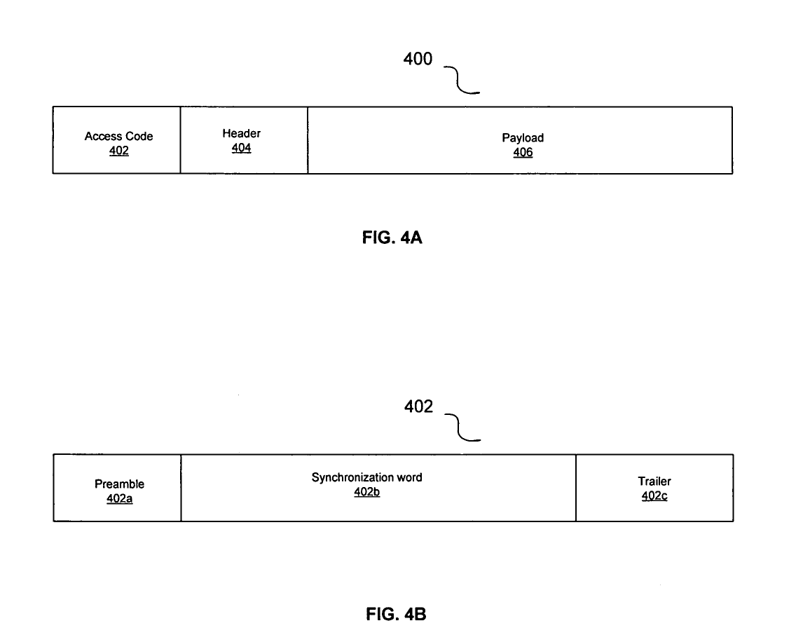

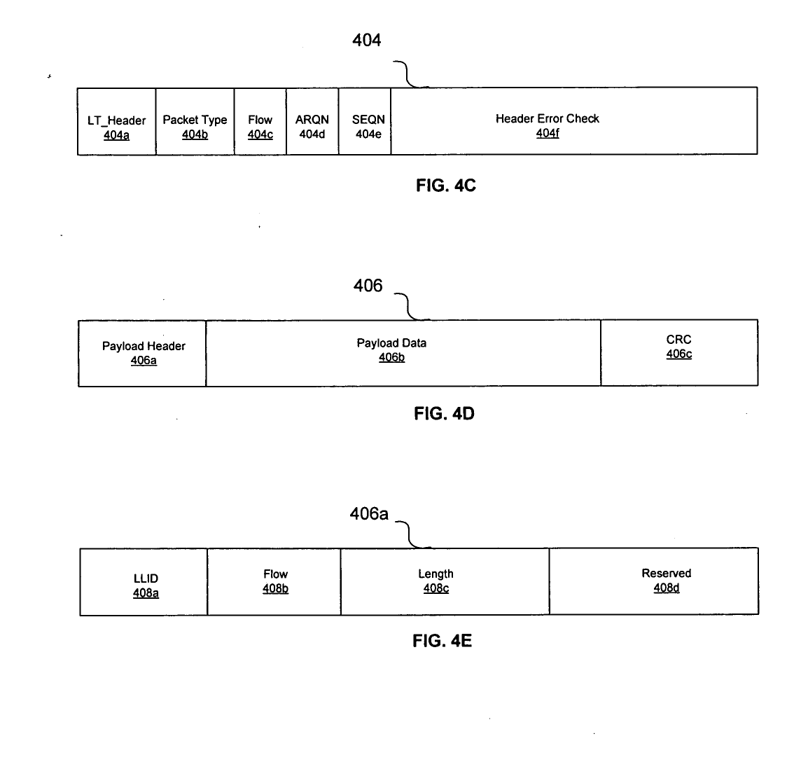

FIG. 4A is a diagram of a Bluetooth data packet, which may be utilized in connection with an embodiment of the invention. Referring to FIG. 4A, there is shown a Bluetooth packet 400 comprising an access code field 402, a header field 404, and a payload field 406. The access code field 402 may be 68 bits or 72 bits in length, and may be used by a receiving Bluetooth device to synchronize to the received Bluetooth packet. The header field 404 may be 54 bits in length, and may be used to indicate a destination slave for a packet, and whether the packet is a synchronous connection oriented (SCO) packet or an asynchronous connectionless (ACL) packet. The payload field 406 may vary in length from zero bits to 2745 bits.

The access code field 402 may indicate various types of access codes. One exemplary type may be a channel access code, which may be used by all Bluetooth devices in a piconet. The channel access code may be derived by using a portion of a Bluetooth device address for the master device in a piconet. The Bluetooth device address may be a 48-bit IEEE media access controller (MAC) address. Another exemplary type may be a device access code used by a master device for paging a specific device. Another exemplary type may be general inquiry access code that may be used by all devices in a piconet during inquiry procedures. Another exemplary type may be a dedicated inquiry access code that may be used for inquiry procedures between specific devices.

The header field 404 may comprise an 18-bit header where each bit may be transmitted three times to improve operation of a Bluetooth link. The header field may comprise various sub-fields that may indicate among others, for example, destination address, a CRC for the header, and whether the packet is a SCO type or an ACL type. The payload field 406 may comprise a payload header, payload data, and payload CRC fields.

FIG. 4B is a diagram of an access code field of a Bluetooth data packet, which may be utilized in connection with an embodiment of the invention. Referring to FIG. 4B, there is shown a preamble field 402a, a synchronization word field 402b, and a trailer field 402c.

The preamble field 402a may comprise four bits that may be used by a receiving Bluetooth device to detect edges of the packet. The preamble may be either “1010” or “0101.” If the least significant bit of the synchronization word field 402b is a “1,” the preamble may be “1010.” If the least significant bit of the synchronization word field 402b is a “0,” the preamble may be “0101.” The least significant bit of the synchronization word may be the first bit transmitted and the most significant bit of the significant word may be the last bit transmitted.

The synchronization word field 402b may be populated with a 64-bit synchronization word. The synchronization word may be a 64-bit code that may be derived from the master's lower address part (LAP) of the Bluetooth device address. The Bluetooth device address may be a 48-bit IEEE media access controller (MAC) address. The 64-bit code may have a large Hamming distance between synchronization words based on different addresses. In addition, the 64-bit code may have good auto-correlation and cross-correlation properties that may improve the timing synchronization process.

The trailer field 402c may be present when the header field 404 is present. The trailer field 402b may comprise a fixed zero-one pattern of four symbols used for fine compensation. The sequence may be “1010” or “0101” depending on whether the most significant bit of the synchronization word is “0” or “1,” respectively.

FIG. 4C is a diagram of a header field of a Bluetooth data packet, which may be utilized in connection with an embodiment of the invention. Referring to FIG. 4C, there is a LT_ADDR field 404a, Packet Type field 404b, Flow field 404c, ARQN field 404d, SEQN field 404e, and Header Error Check field 404f. The LT_ADDR field 404a may be a 3-bit field comprising logical transport address 1-7 that may indicate a specific slave device. Each of the slave devices in a piconet may be assigned a logical transport address by the master device. A logical transport address of 0 may indicate a broadcast to all of the slave devices. The master device may not have a logical transport address.

The Packet Type field 404b may be, for example, a 4-bit field that may indicate the type of traffic that may be carried by the packet. Accordingly, 16 different types of packets may be defined. The packet type may distinguish between SCO packets and ACL packets. The packet type may also indicate the number of Bluetooth slots that the packet may use. Accordingly, the slave devices that are not to receive the packet may save power by going to standby mode for the duration of the packet length.

The Flow field 404c may be a 1-bit field. This field may be asserted when the Bluetooth device is unable to receive any more data, for example, due to the receive buffer being full. The ARQN field 404d may be a 1-bit field. This field may be used to acknowledge to the sender whether the reception of the packet in the preceding slot was successful (ARQN=1) or unsuccessful (ARQN=0). If no valid ARQN field is received, ARQN=0 may be assumed. ARQN=0 may be the default value. The ARQN field may be piggy-backed in the return packet. Whether a reception of a previous packet was successful may be checked by means of a cyclic redundancy check (CRC), which may be added to each payload that contains data.

The SEQN field 404e may comprise a single bit, for example. This bit may be toggled by a transmitting Bluetooth device for each successive packet transmitted. Accordingly, the receiving Bluetooth device may be able to determine whether two successive packets may be different packets. If the two successive packets have different SEQN field values, the successive packets may be different packets. If the two successive packets have the same SEQN field value, then the receiving device may assume that the second packet may be a re-transmit of the first packet, and the second packet may be discarded.

The header error-check field 404f may comprise eight bits of CRC. The transmitting Bluetooth device may calculate the CRC for the 10 header bits in the header fields 404a, 404b, 404c, 404d, and 404e. If the CRC check done by the receiving Bluetooth device fails, the packet may be discarded. Each bit of the 18-bit header field may be transmitted, for example, three times in order to increase the integrity of the header field when it is received by a Bluetooth device.

FIG. 4D is a diagram of a payload field of a Bluetooth data packet, which may be utilized in connection with an embodiment of the invention. Referring to FIG. 4D, there is shown a Payload Header field 406a, a Payload Data field 406b, and a Payload CRC field 406c. The Payload Header field 406a may comprise eight bits for a single slot packet and 16 bits for multi-slot packets. The Payload Data field 406b may comprise up to 2712 bits of data, and the CRC field may comprise 16 bits. If the packet is a SCO packet, the CRC field may not be used.

FIG. 4E is a diagram of a payload header field of a Bluetooth data packet, which may be utilized in connection with an embodiment of the invention. Referring to FIG. 4E, there is shown the Payload Header field 406a comprising the LLID field 408a, the Flow field 408b, the Length field 408c, and a reserved field 408d. The LLID field 408a may comprise two bits and the Flow field 408b may comprise one bit. The Length field 408c may indicate the number of bytes of data in a payload, and may comprise five bits for a single slot packet, and 9 bits for a multi-slot packet. The reserved field 408d may four bits, and may not be present for single slot packets.

The LLID field 408a may indicate whether the packet is a first packet of a logical link control and adaptation protocol (L2CAP) message, a continuation of an L2CAP message, or a link manager protocol (LMP) message. The LMP messages may be used to set up a link between two Bluetooth devices. The L2CAP messages may be a long message that may have been segmented by the L2CAP layer.

The Flow field 408b may be asserted when the L2CAP layer is unable to receive any more data, for example, due to the receive buffer being full. The Length field 408c may indicate the number of bytes in the Payload Data field 406b. The reserved field 408d may comprise bits that may not be used.

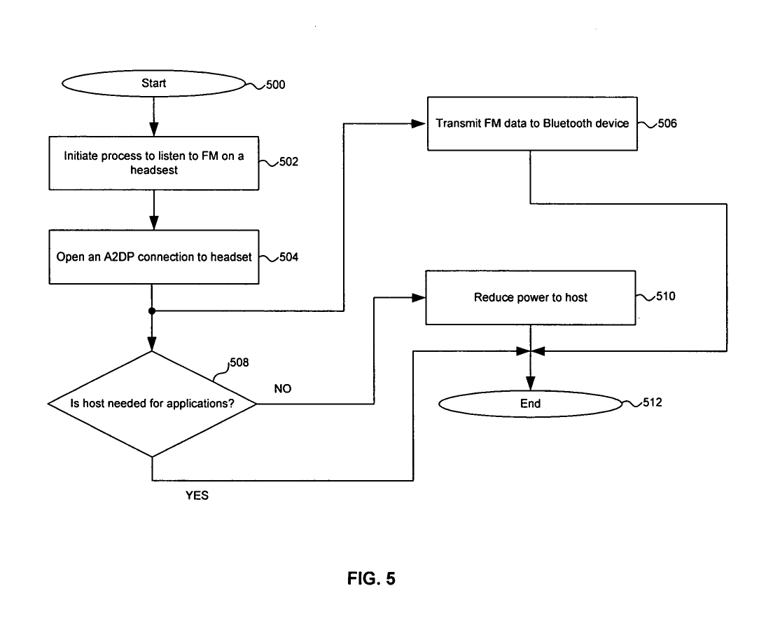

FIG. 5 is a flow diagram that illustrates exemplary steps for communicating FM data to a Bluetooth enabled headset, in accordance with an embodiment of the invention. Referring to FIG. 5, there is shown steps 500 to 512. In step 502, after the start step 500, a user of a mobile terminal 200 that is capable of receiving FM broadcasts may initiate a process to listen to the FM broadcast on a Bluetooth enabled headset 112, for example. Accordingly, the host 210 may send at least one command to the BT-FM chip 220 to establish an A2DP link with the Bluetooth enabled headset 112. In step 504, the BT-FM chip 220 may negotiate with the Bluetooth enabled headset 112 to open an A2DP link between the mobile terminal 200 and the Bluetooth enabled headset 112. The next step may be steps 506 and 508. In step 506, the BT-FM chip 220 may communicate the received FM broadcast to the Bluetooth enabled headset 112 without further intervention from the host 210. The next step may be the end step 512.

In step 508, the host 210 may determine whether to reduce power to various portions of the mobile terminal 200. Alternatively, power management may be handled by the PMU 316, or another power management unit in the mobile terminal 200. If portions of the mobile terminal 200 can be powered down, then the next step may be step 510. Otherwise, the next step may be the end step 512. In step 510, portions of the mobile terminal 200 that do not need to be active may be powered down. The next step may be the end step 512.

In step 510, if the processor 212 is not needed for any other functionality, such as, for example, Bluetooth communication or cellular communication, the processor 212 may enter a sleep mode for a period of time. This may be a reduced power state whereby battery power for the mobile terminal 200 may be conserved. The processor 212 may exit the sleep mode after the period of time has elapsed. For example, the processor 212 may awake after a period in which a certain number of slot times have elapsed if a Bluetooth transmission was taking place when the processor 212 went in to sleep mode. The processor 212 may also be awakened by a signal from circuitry that, for example, may have detected incoming cellular signals, or an action by the user. For example, the user may press a button to dial a number. The specific power saving sleep mode and determining when to awaken from the sleep mode may be design and/or implementation dependent.

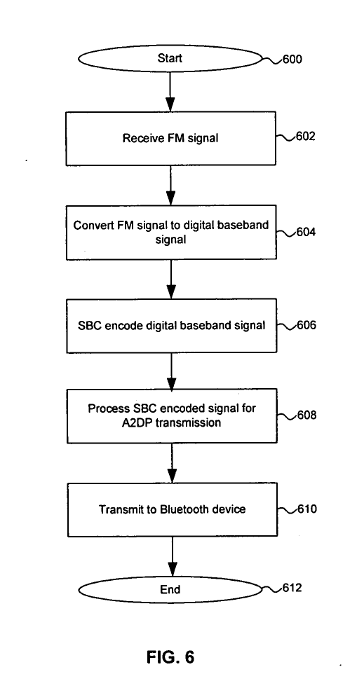

FIG. 6 is a flow diagram that illustrates exemplary steps for processing FM signals for communication to a Bluetooth enabled headset, in accordance with an embodiment of the invention. Referring to FIG. 6, there is shown steps 600 to 612. In step 602, after the start step 600, the FM signal may be received by, for example, the FM receiver 322. In step 604, the FM receiver 322 may convert the received FM signal to corresponding digital baseband FM signal. The digital baseband FM signal may have been sampled at, for example, 48 kilo-samples per second by the ADC 324, and may comprise left and right channel information of the received FM signal. In step 606, the digital baseband FM signal may be SBC encoded by, for example, the SBC codec 320. In step 608, the SBC encoded signal may be communicated to the Bluetooth core 306. The Bluetooth core 306 may process the SBC encoded signal for A2DP transmission to the Bluetooth enabled headset 112, for example. The Bluetooth core 306 may encapsulate the SBC encoded data with needed headers and trailers, and also appropriately filter, modulate, and amplify for transmission. In step 610, the A2DP signal from step 608 may be transmitted via the first antenna 366a to other Bluetooth devices. The next step may be the end step 612.

In accordance with an embodiment of the invention, aspects of an exemplary system may comprise a single chip with integrated Bluetooth radio and FM radio, such as, for example, the BT-FM chip 220, which enables conversion and processing of received FM data, or FM signals, to A2DP format. The processing may result in generation of a digital baseband data by, for example, the FM receiver 322. The digital baseband data may be communicated to the processor system 302 for SBC encoding. The SBC encoded data may be communicated to the Bluetooth core 306 for A2DP formatting. The A2DP formatted data may be appropriately modulated, filtered, amplified, and/or converted to analog signals by the Bluetooth radio, such as, for example, the Bluetooth transmitter/receiver 329. The A2DP formatted signal may then be transmitted to a Bluetooth device via an A2DP link.

The BT-FM chip 220 may receive a signal, or a command, from the host 210, and may initiate a process to convert and transmit the FM data to at least one Bluetooth device via the A2DP link. The initiation may be via, for example, signals or commands received across the HCI 222. The conversion of the FM data may be executed without further intervention from the host 210 after the initiation by the host 210. Accordingly, power may be reduced to at least a portion of the host 210 during the conversion if the host 210 is not needed for other processes. For example, the host 210 may be needed to handle incoming calls or outgoing calls.

The A2DP formatted data may comprise left channel and right channel information of the FM data. The A2DP formatted FM data may comprise baseband signal of the received FM data digitally sampled at 48 kilo-samples per second by, for example, the ADC 324.

Another embodiment of the invention may provide a machine-readable storage, having stored thereon, a computer program having at least one code section executable by a machine, thereby causing the machine to perform the steps as described above for routing of FM data to a Bluetooth A2DP link.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for providing wireless communication, the method comprising:
converting within a single chip comprising an integrated Bluetooth radio and an integrated FM radio, FM data to A2DP format; and
communicating said A2DP formatted FM data to a Bluetooth device via an ACL link using an A2DP profile.

2. The method according to claim 1, comprising receiving by said single chip of at least one signal from a host that causes initiation of a process to transmit said FM data to said at least one Bluetooth device via said ACL link using said A2DP profile.

3. The method according to claim 2, wherein after said receiving by said single chip of said at least one signal from said host, said converting is done without further intervention from said host.

4. The method according to claim 2, comprising reducing an amount of power supplied to at least a portion of said host during said converting.

5. The method according to claim 1, wherein said A2DP formatted FM data comprises left channel and right channel information of said FM data.

6. The method according to claim 1, wherein said A2DP formatted FM data comprises baseband signal of said FM data digitally sampled at 48 kilo-samples per second.

7. The method according to claim 1, comprising SBC encoding of said FM data.

8. A machine-readable storage having stored thereon, a computer program having at least one code section for wireless communication, the at least one code section being executable by a machine for causing the machine to perform steps comprising:
converting within a single chip comprising an integrated Bluetooth radio and an integrated FM radio, FM data to A2DP format; and
communicating said A2DP formatted FM data to a Bluetooth device via an ACL link using an A2DP profile.

9. The machine-readable storage according to claim 8, comprising code for receiving by said single chip of at least one signal from a host that causes initiation of a process to transmit said FM data to said at least one Bluetooth device via said ACL link using said A2DP profile.

10. The machine-readable storage according to claim 9, wherein after said receiving by said single chip of said at least one signal from said host, said converting is done without further intervention from said host.

11. The machine-readable storage according to claim 9, comprising code that allows reducing an amount of power supplied to at least a portion of said host during said converting.

12. The machine-readable storage according to claim 8, wherein said A2DP formatted FM data comprises left channel and right channel information of said FM data.

13. The machine-readable storage according to claim 8, wherein said A2DP formatted FM data comprises baseband signal of said received FM data digitally sampled at 48 kilo-samples per second.

14. The machine-readable storage according to claim 8, comprising code that allows SBC encoding of said FM data.

15. A system for providing wireless communication, the system comprising:
a single chip comprising an integrated Bluetooth radio, an integrated FM radio, and circuitry that enables conversion of FM data to A2DP format; and
said circuitry enables communication of said A2DP formatted FM data to a Bluetooth device via an ACL link using an A2DP profile.

16. The system according to claim 15, wherein said single chip receives at least one signal from a host that causes initiation of a process to transmit said FM data to said at least one Bluetooth device via said ACL link using said A2DP profile.

17. The system according to claim 17, wherein after receipt by said single chip of said at least one signal from said host, said conversion is done without further intervention from said host.

18. The system according to claim 17, comprising circuitry that enables reduction of an amount of power supplied to at least a portion of said host during said conversion.

19. The system according to claim 15, wherein said A2DP formatted FM data comprises left channel and right channel information of said FM data.

20. The system according to claim 15, wherein said A2DP formatted FM data comprises baseband signal of said FM data digitally sampled at 48 kilo-samples per second.

21. The system according to claim 15, comprising an SBC encoder that enables SBC encoding of said processed received FM data.
